(19) United States
(12) Patent Application Publication
(10) Pub. No.: US 2009/0110190 A1
(43) Pub. Date: Apr. 30, 2009

(54) FAST SECURE BOOT IMPLEMENTATION

(75) Inventors: Boris Dolgunov, Ramat Gan (IL); Leonid Minz, Beersheba (IL)

Correspondence Address: SanDisk;c/o DARBY & DARBY PC, P.O. Box 770, Church Street Station, New York, NY, 10008, US

(73) Assignee: Sandisk IL Ltd., Kfar Saba (IL)

(21) Appl. No.: 12/258,641

(22) Filed: Oct. 27, 2008

(30) Foreign Application Priority Data
Oct. 30, 2007 (IL) 187044

(51) Int. Cl. H04L 9/30; H04L 9/06

(52) U.S. Cl. 380/30; 713/189

(57) ABSTRACT

A method for data storage includes employing a first CPU to execute code from a ROM associated therewith. A second CPU is employed to upload code from a flash memory to a code RAM associated with the first CPU, while the first CPU is available to perform other tasks.

### FIELD OF THE INVENTION

The present invention relates to data storage devices generally and more particularly to data storage devices including a flash memory.

### BACKGROUND OF THE INVENTION

Memory systems may include a cryptographic engine implemented in hardware or software. Such systems typically include a boot strapping mechanism wherein a first portion of firmware when executed pulls in another portion of firmware to be executed.

Similarly, a method may be used for booting a microprocessor system using a serial flash memory array. The method typically includes loading a boot code loader stored in the serial flash memory array into a random access memory (RAM) when power is turned on, according to a routine of a read-only memory of the microprocessor, loading boot code stored in the serial flash memory into an internal or external RAM of the microprocessor according to the boot code loader, loading application code stored in the serial flash memory into the main memory according to the boot code and executing the application code.

### SUMMARY OF THE INVENTION

Some embodiments of the present invention seeks to provide improved data storage devices including a flash memory. There is thus provided in accordance with a preferred embodiment of the present invention a storage device including a first central processing unit (CPU), a code RAM associated with the first CPU, a flash memory storing code and a second CPU controlling upload of code from the flash memory to the code RAM.

There is also provided in accordance with another preferred embodiment of the present invention a method for data storage including employing a first CPU to execute code from a read-only memory (ROM) associated therewith and employing a second CPU to upload code from a flash memory to a code RAM associated with the first CPU, while the first CPU is available to perform other tasks.

Preferably, the second CPU includes code integrity verification functionality. Additionally, the code integrity verification functionality includes at least one of the following functionalities: SHA1 (Secure Hash Algorithm 1), SHA256 (Secure Hash Algorithm 256), SHA384 (Secure Hash Algorithm 384), SHA512 (Secure Hash Algorithm 512), RC5 (Rivest Cipher 5), CMAC (Cipher based Message Authentication Code) and HMAC (keyed Hash Message Authentication Code).

Additionally or alternatively, the code integrity verification functionality includes a signature using a public key (PK) algorithm. Additionally, the public key (PK) algorithm includes at least one of the following algorithms: RSA (Rivest, Shamir, Adleman), DSA (Digital Signature Algorithm) and ECDSA (Elliptic Curve DSA).

Preferably, the second CPU has access to verification keys required to support the code integrity verification functionality and the first CPU does not have access to the verification keys.

Preferably, the second CPU includes code decryption functionality. Additionally, the code decryption functionality includes at least one of the following functionalities: AES (Advanced Encryption Standard), DES (Data Encryption Standard), 3DES (Triple DES) and RC4 (Rivest Cipher 4).

Preferably, the second CPU includes at least one cryptographic accelerator. Preferably, the second CPU includes at least one hardware accelerator.

Preferably, the storage device also includes a host interface interposed between a host and the flash memory. Preferably, the first CPU has a first ROM and the second CPU has a second ROM associated therewith.

There is further provided in accordance with yet another preferred embodiment of the present invention a method for data storage including providing a storage device including a first CPU having a first ROM associated therewith, a code RAM associated with the first CPU, a flash memory storing code, a host interface interposed between a host and the flash memory and a second CPU controlling upload of code from the flash memory to the code RAM, the second CPU having a second ROM associated therewith, operating the first CPU to perform execution for the first ROM, operating the second CPU to perform execution for the second ROM, employing the first CPU for initialization and generally simultaneously therewith employing the second CPU to upload and verify at least a portion of the code from the flash memory and following the upload and verification of the at least a portion of the code received from the flash memory by the second CPU, operating the first CPU for execution of the at least a portion of the code.

Preferably, the method also includes, following initialization, operating the first CPU to communicate with the host and to send an “answer to reset” command.

### BRIEF DESCRIPTION OF THE DRAWING

The present invention will be understood and appreciated more fully from the following detailed description taken in conjunction with the drawing in which:

FIG. 1 is a simplified block diagram illustration of a data storage device constructed and operative in accordance with a preferred embodiment of the present invention.

### DETAILED DESCRIPTION OF A PREFERRED EMBODIMENT

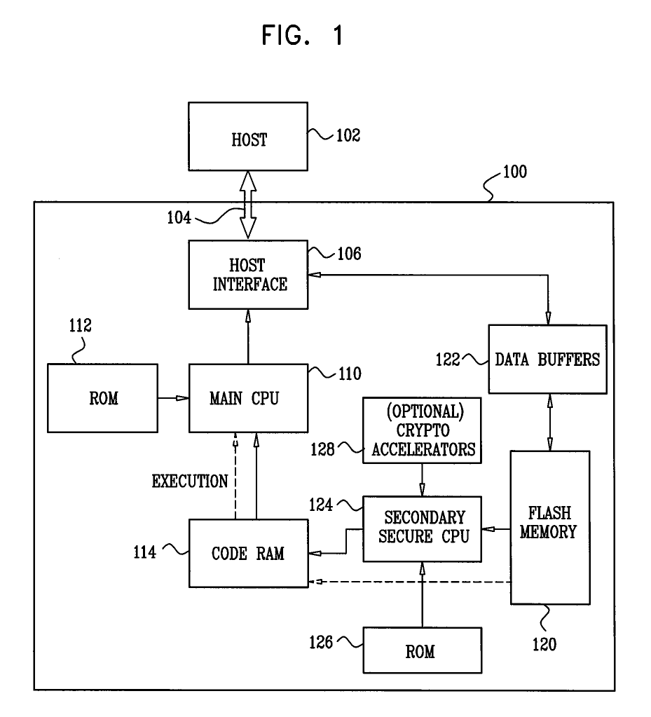

Reference is now made to FIG. 1, which is a simplified block diagram illustration of a data storage device constructed and operative in accordance with a preferred embodiment of the present invention. As seen in FIG. 1, a data storage device 100 communicates with a host 102 via a data bus 104 and a host interface 106, forming part of the data storage device.

The operation of the data storage device 100 is governed by a main CPU 110 having a ROM 112 associated therewith. A code RAM 114 is associated with the main CPU 110. A flash memory 120 stores code to be supplied to the code RAM 114. Data is communicated between the host interface 106 and flash memory 120 via data buffers 122.

It is a particular feature of the present invention that a secondary, secure CPU 124 controls upload of code from the flash memory 120 to the code RAM 114. The secondary, secure CPU 124 preferably has a ROM 126 associated therewith and optionally also has cryptographic accelerators 128 associated therewith.

Preferably, the secondary, secure CPU 124 provides code integrity verification functionality, such as one or more of the following functionalities: SHA1 (Secure Hash Algorithm 1), SHA256 (Secure Hash Algorithm 256), SHA384 (Secure Hash Algorithm 384), SHA512 (Secure Hash Algorithm 512), RC5 (Rivest Cipher 5), CMAC (Cipher based Message Authentication Code), HMAC (keyed Hash Message Authentication Code). The code integrity verification functionality may also include a signature using a public key (PK) algorithm, such as one or more of the following algorithms: RSA (Rivest, Shamir, Adleman), DSA (Digital Signature Algorithm), ECDSA (Elliptic Curve DSA).

Preferably, the secondary, secure CPU 124 also provides decryption functionality, such as one or more of the following functionalities: AES (Advanced Encryption Standard), DES (Data Encryption Standard), 3DES (Triple DES), RC4 (Rivest Cipher 4).

It is a particular feature of the present invention that the main CPU 110 can be employed to execute code from ROM 112 associated therewith and the secondary, secure CPU 124 can be employed to upload code from flash memory 120 to code RAM 114 associated with the main CPU 110, while CPU 110 is available to perform other tasks.

It is appreciated that secondary, secure CPU 124 may include hardware accelerators (not shown) to enable faster code upload and verification.

The present invention also provides a method for data storage including operating the main CPU 110 to perform execution for ROM 112 and operating CPU 124 to perform execution for ROM 126, employing main CPU 110 for initialization and generally simultaneously therewith employing the secondary CPU 124 to upload and verify at least a portion of code from the flash memory 120 and following the upload and verification of at least a portion of the code received from flash memory 120 by secondary CPU 124, operating main CPU 110 for execution of at least a portion of that code.

Preferably, following initialization thereof, the main CPU 110 communicates with host 102 and sends an “answer to reset” command.

The present invention also provides a method for secure data upload, after reset or power up, including operating the main CPU 110 to perform execution for ROM 112 and operating CPU 124 to perform execution for ROM 126, employing main CPU 110 for initialization and generally simultaneously therewith employing the secondary CPU 124 to upload and verify at least a portion of code from the flash memory 120 and following the upload and verification of at least a portion of the code received from flash memory 120 by secondary CPU 124, operating main CPU 110 for execution of at least a portion of that code.

It is appreciated that the implementation of the secondary, secure CPU 124 can be substantially smaller than the main CPU 110 and therefore requires lower power consumption. Secondary, secure CPU 124 is preferably operative to upload code and verify the code being uploaded from flash memory 120 both during the boot process and in run time to enable optimal execution. It is appreciated that secondary, secure CPU 124 may be operative to upload all, or only a portion, of the code available in flash memory 120 to RAM 114.

It is appreciated that code stored in flash memory 120, for supplying to the code RAM 114, is preferably loaded into flash memory 120 during the manufacture of data storage device 100.

Additionally, the signature used by the code integrity verification functionality may be a signature unique to storage device 100 which is loaded into flash memory 120 during manufacture or generated by the flash memory 120. Alternatively, the signature may be based on a public key (PK) algorithm and may be identical for multiple data storage devices 100 and may be stored either in the flash memory 120 or ROM 126.

As described hereinabove, the secondary, secure CPU 124 preferably includes the following functionalities: initialization of flash memory 120, reading flash memory 120, uploading code from flash memory 120 to RAM 114, verification of code being uploaded and decryption functionality.

It is appreciated that the code integrity verification functionality may be operative to provide a signal to main CPU 110 if the verification functionality failed to verify the code being uploaded from flash memory 120. Alternatively, secondary, secure CPU 124 may be operative to disable code uploads if the verification functionality failed to verify the code being uploaded from flash memory 120. In another alternative embodiment, secondary, secure CPU 124 may be operative to terminate operation of either itself or main CPU 110, or both, if the verification functionality failed to verify the code being uploaded from flash memory 120.

The provision of secondary, secure CPU 124 also provides additional security in that only secure CPU 124, and not main CPU 110, has access to verification keys required to support the code integrity verification functionality.

It is appreciated the secondary, secure CPU 124 may also provide a download functionality, including signing an image of software downloaded to flash memory 120.

It will be appreciated by persons skilled in the art that the present invention is not limited to what has been particularly shown and described hereinabove. Rather the scope of the invention includes both combinations and subcombinations of the various features described hereinabove as well as modifications and variations thereof which would occur to persons skilled in the art upon reading the foregoing description and which are not in the prior art.

1. A method for data storage comprising:
employing a first CPU to execute code from a ROM associated therewith; and
employing a second CPU to upload code from a flash memory to a code RAM associated with said first CPU, while said first CPU is available to perform other tasks.

2. A method according to claim 1 and wherein said second CPU includes code integrity verification functionality.

3. A method according to claim 2 and wherein said code integrity verification functionality includes at least one of the following functionalities: SHA1 (Secure Hash Algorithm 1), SHA256 (Secure Hash Algorithm 256), SHA384 (Secure Hash Algorithm 384), SHA512 (Secure Hash Algorithm 512), RC5 (Rivest Cipher 5), CMAC (Cipher based Message Authentication Code) and HMAC (keyed Hash Message Authentication Code).

4. A method according to claim 2 and wherein said code integrity verification functionality includes a signature using a public key (PK) algorithm.

5. A method according to claim 4 and wherein said public key (PK) algorithm includes at least one of the following algorithms: RSA (Rivest, Shamir, Adleman), DSA (Digital Signature Algorithm) and ECDSA (Elliptic Curve DSA).

6. A method according to claim 1 and wherein said second CPU includes code decryption functionality.

7. A method according to claim 6 and wherein said code decryption functionality. includes at least one of the following functionalities: AES (Advanced Encryption Standard), DES (Data Encryption Standard), 3DES (Triple DES) and RC4 (Rivest Cipher 4).

8. A method according to claim 1 and wherein said second CPU comprises at least one cryptographic accelerator.

9. A method according to claim 1 and wherein said second CPU comprises at least one hardware accelerator.

10. A method for data storage comprising:
providing a storage device including a first CPU having a first ROM associated therewith, a code RAM associated with said first CPU, a flash memory storing code; a host interface interposed between a host and said flash memory and a second CPU controlling upload of code from said flash memory to said code RAM, said second CPU having a second ROM associated therewith;
operating said first CPU to perform execution for said first ROM;
operating said second CPU to perform execution for said second ROM;
employing said first CPU for initialization and generally simultaneously therewith employing said second CPU to upload and verify at least a portion of said code from said flash memory; and
following said upload and verification of said at least a portion of said code received from said flash memory by said second CPU, operating said first CPU for execution of said at least a portion of said code.

11. A method according to claim 10 and also comprising following initialization, operating said first CPU to communicate with said host and to send an “answer to reset” command.

12. A method according to claim 10 and wherein said second CPU comprises at least one cryptographic accelerator.

13. A method according to claim 10 and wherein said second CPU comprises at least one hardware accelerator.

14. A method for data storage comprising:
providing a first CPU and a code RAM associated with the first CPU;
providing a flash memory storing code and a second CPU; and
controlling, by the second CPU, upload of code from the flash memory to the code RAM.
